(19) United States
(12) Patent Application Publication
(10) Pub. No.: US 2013/0147742 A1
(43) Pub. Date: Jun. 13, 2013

(54) TOUCH PANEL

(71) Applicant: Samsung Electro-Mechanics Co., Ltd., Gyunggi-do (KR)

(72) Inventor: Wan Jae Lee, Gyunggi-do (KR)

(73) Assignee: Samsung Electro-Mechanics Co., Ltd., Gyunggi-so (KR)

(21) Appl. No.: 13/712,704

(22) Filed: Dec. 12, 2012

(30) Foreign Application Priority Data
Dec. 12, 2011 (KR) 10-2011-0133191

(51) Int. Cl. G06F 3/041

(52) U.S. Cl. CPC G06F 3/041
USPC 345/173

(57) ABSTRACT

Disclosed herein is a touch panel. The touch panel according to a preferred embodiment of the present invention is configured to include a window, a printing part buried in a depressed part formed on one surface of the window; a transparent substrate; an electrode pattern formed on one surface or both surfaces of the transparent substrate; and an adhesive layer bonding the transparent substrate to one surface of the window. By this configuration, it is possible to minimize the occurrence of bubbles on the adhesive layer by removing the step occurring due to a thickness of a printing part by burying the printing part in one surface of the window.

### CROSS REFERENCE TO RELATED APPLICATION

This application claims the benefit of Korean Patent Application No. 10-2011-0133191, filed on Dec. 12, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

Meanwhile, the touch panel is classified into a resistive type, a capacitive type, an electromagnetic type, a surface acoustic wave (SAW) type, and an infrared type. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, as disclosed in Korean Patent Laid-Open Publication No. 10-2010-0118680, the touch panel according to the prior art has a printing layer formed on a first upper transparent film that is disposed at an outermost portion thereof so as to cover an electrode wiring, and the like. However, the printing layer has a predetermined thickness and therefore, a step occurs. As a result, when the first upper transparent film and a second upper transparent film are bonded to each other by an optical adhesive film, bubbles may occur on the optical adhesive film due to the step of the printing part. In order to prevent the occurrence of the bubbles as maximally as possible, a method for forming the optical adhesive film thicker has been used In this case, there are problems in that the overall thickness of the touch panel may be thick and the sensing sensitivity may be degraded. Further, there is a need to forcibly increase a pressure within an autoclave in order to remove the generated bubbles.

### SUMMARY OF THE INVENTION

The present invention has been made in an effort to provide a touch panel capable of minimizing occurrence of bubbles on an adhesive layer bonding a window to a transparent substrate by removing a step occurring due to a thickness of a printing part by burying the printing part on one surface of the window.

According to a preferred embodiment of the present invention, there is provided a touch panel including: a window; a printing part buried in a depressed part formed on one surface of the window; a transparent substrate; an electrode pattern formed on one surface or both surfaces of the transparent substrate; and an adhesive layer bonding the transparent substrate to one surface of the window.

A thickness of the depressed part and a thickness of the printing part may be the same.

The printing part may be formed by sputter.

A color of the printing part may be black, white, gold, red, green, yellow, gray, violet, brown, and blue, or a combination thereof.

The adhesive layer may be an optical clear adhesive (OCA).

The touch panel may further include an electrode wiring connected with the electrode pattern.

The electrode wiring may be integrally formed with the electrode pattern.

The touch panel may further include a flexible printed circuit board connected with the electrode wiring.

The electrode pattern may be formed of copper (Cu), aluminum (Al), gold (Au), silver (Ag), titanium (Ti), palladium (Pd), and chromium (Cr), or a combination thereof.

The electrode pattern may be formed of metal silver formed by exposing/developing a silver salt emulsion layer.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are cross-sectional views of a touch panel according to a preferred embodiment of the present invention.

### DESCRIPTION OF THE PREFERRED EMBODIMENTS

The above and other objects, features and advantages of the present invention will be more clearly understood from preferred embodiments and the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

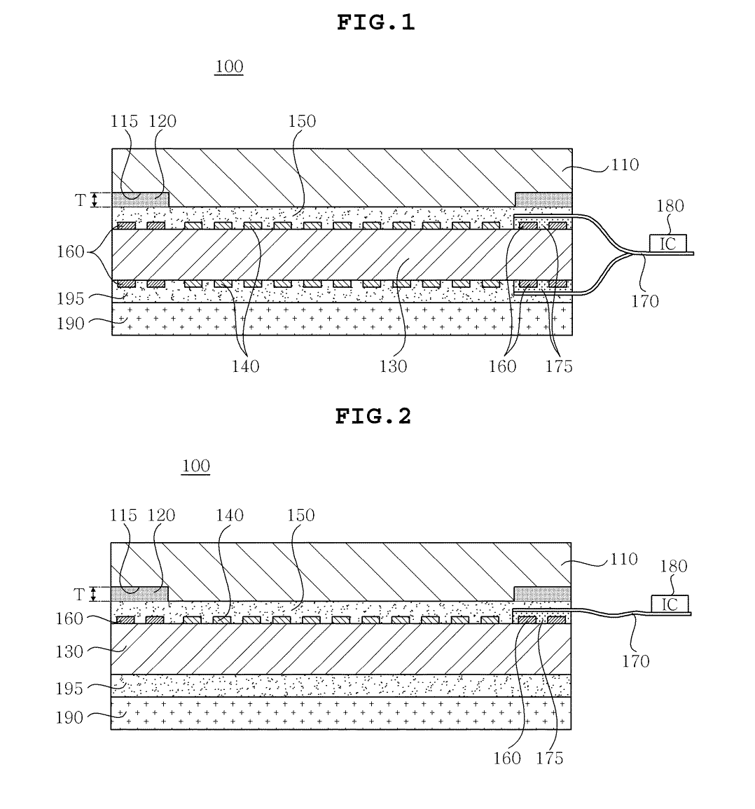

FIGS. 1 to 3 are cross-sectional views of a touch panel according to a preferred embodiment of the present invention.

As illustrated in FIGS. 1 to 3, a touch panel 100 according to a preferred embodiment of the present invention is configured to include a window 110, a printing part 120 buried in a depressed part 115 formed on one surface of the window 110, a transparent substrate 130, electrode patterns 140 formed on one surface or both surfaces of the transparent substrate 130, and an adhesive layer 150 bonding the transparent substrate 130 to one surface of the window 110.

The window 110 is disposed at an outermost portion of the touch panel 100 to protect internal components of the touch panel 100 such as an electrode pattern 140, an electrode wiring 160, and the like, and receives a touch by a user from the other surface (an opposite surface to one surface in which the printing part 120 is buried). Here, a material of the window 110 is not particularly limited, but the window may be made of glass, tempered glass, and the like. Meanwhile, one surface of the window 110 is provided with a depressed part 115 in which the printing part 120 is buried.

The printing part 120 serves to cover an electrode wiring 160 or display a logo, and the like, and is buried in the depressed part 115 that is formed on one surface of the window 110. Here, the printing part 120 generally has a relatively thick thickness in a micrometer unit. However, the printing part 120 is buried in the depressed part 115 of the window 110 to prevent a step from occurring between the printing part 120 and the window 110. As such, it is possible to minimize the occurrence of bubbles on the adhesive layer 150 bonding the window 110 to the transparent substrate 130 by preventing the step from occurring. Further, in order to completely prevent the step from occurring between the printing part 120 and the window 110, a thickness T of the depressed part 115 and a thickness T of the printing part 120 need to be the same. Here, the meaning of the “same” does not mean that the thickness T of the depressed part 115 and the thickness T of the printing part 120 are the mathematically complete same, but includes a slight change in a thickness due to a machining error, and the like, that occurs during a manufacturing process of the touch panel 100.

Meanwhile, the printing part 120 may be formed by using, for example, screen printing, sputter, and the like. Among others, when the printing part 120 is formed by the sputter, the thickness T of the printing part 120 may be formed thinly as small as a nanometer unit and the thickness T of the depressed part 115 may be formed thinly corresponding to the thickness T of the printing part 120.

Further, a color of the printing part 120 may be black, white, gold, red, green, yellow, gray, violet, brown, and blue, or a combination thereof. Materials for forming the printing part 120 in each color as described above will be described below in detail

First, when carbon-based materials (graphene oxide, diamond line carbon (DLC), chromium-based oxide (CrO, CrO₂), copper-based oxide (CuO), manganese-based oxide (MnO₂), cobalt-based oxide (CoO), sulfides (CoS₂, Co₃S₄), nickel-based oxide (Ni₂O₃), HgTe, YBa₂Cu₃O₇, MoS₂, RuO₂, PdO, InP, SnO, TaN, TaS₂, and the like, are used, the printing part 120 may be formed in black.

Further, when titanium-based oxide (TiO₂), aluminum-based oxide (Al₂O₃), magnesium-based oxide (MgO), sodium-based oxide (Na₂O), lithium-based oxide (Li₂O), beryllium-based oxide (BeO), magnesium-based sulfides (MgS), MgF2, MgCo₃, ZnO, ZnS, KNO₃, KCl, KOH, Ga₂O₃, RbCl, RbF, BaTiO₃, BaSO₄, BaCl₂, BaO, Ba(NO₃)₂, BaCO₃, BaOH, BaB₂O₄, SrTiO₃, SrCl₂, SrO, Y₂O₃, YCl₃, YF₃, ZrO₂, ZrCl₄, ZrF₄, Nb₂O₅, NbOCl₃, Mo(CO)₆, CdCl₂, InCl₃, SnO₂, Sb₂O₃, CsI, CsCl, CsF, Ta₂O₅, TaCl₅, TaF₅, and the like, are used, the printing part 120 may be formed in white.

Further, when titanate nitride (TiN), and the like, is used, the printing part 120 may be formed in gold and when copper-oxide oxide (Cu₂O), iron-based oxide (Fe₂O₃), ZnTe, Tris (bipyridine)ruthenium chloride, PdCl₂, CdSe, and the like, are used, the printing part 120 may be formed in red.

In addition, when chromium-based oxide (Cr₂O₃), MnO, NiO, MoCl₅, bilₐ, and the like, are used, the printing part 120 may be formed in green and when sodium-based oxide (Na₂O₂), K₂O, CaO, V₂O₅, ZnSe, GaN, GaP, Rb₂O, NbCl₅, CdS, CdI₂, 1n₂O₃, Sb₂O₅, Cs₂O, WO₃, Bi₂O₃, and the like, are used, the printing part 120 may be formed in yellow.

In addition, when MgB₂, Si₃N₄, RbOH, BaO₂, ZrC, NbO, MoSi₂, WC, Bi₂Te₃, and the like, are used, the printing part 120 may be formed in gray and when Ru(acac)³, and the like, is used, the printing part 120 may be formed in violet.

Further, when Pd(O₂CCH₃)₂, CdO, InSb, Tantalum carbide, and the like, are used, the printing part 120 may be formed in brown and when WCI6, and the like, is used, the printing part 120 may be formed in blue.

Further, when the materials are combined, the printing part 120 may be formed in a combination of at least two of black, white, gold, red, green, yellow, gray, violet, brown, and blue.

The transparent substrate 130 serves to provide a region in which the electrode pattern 140 and the electrode wiring 160 are formed. Here, the transparent substrate 130 needs to have a support force capable of supporting the electrode pattern 140, the electrode wiring 160, and the like, and transparency to allow a user to recognize images provided from an image display device. In consideration of the support force and the transparency described above, the transparent substrate 130 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but is not necessarily limited thereto.

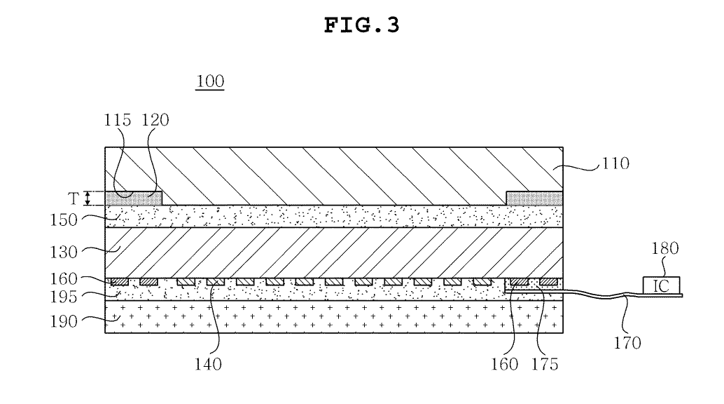

The electrode pattern 140 serves to generate signals when being touched by a user to allow a control unit to recognize touched coordinates and may be formed on both surfaces (see FIG. 1) or one surface (see FIG. 2 or 3) of the transparent substrate 130. Here, the electrode pattern 140 may be formed in a mesh pattern using copper (Cu), aluminum (Al), gold (Au), silver (Ag), titanium (Ti), palladium (Pd), and chromium (Cr), or a combination thereof. In detail, the electrode patterns 140 may be preferably formed of copper (Cu), aluminum (Al), gold (Au), silver (Ag), and the like, all of which have high electric conductivity, but may be formed of all metals having electric conductivity. Further, when the electrode pattern 140 is formed of copper (Cu), a surface of the electrode pattern 140 may be preferably blackened. Here, the blackening elutes Cu₂O or CuO by oxidizing the surface of the electrode pattern 140, wherein the Cu₂O has brown and therefore, is referred to as brown oxide and the CuO has black and therefore, is referred to as black oxide. As such, it is possible to prevent light from being reflected by blackening the surface of the electrode pattern 140, thereby improving the visibility of the touch panel 100.

Further, in addition to the foregoing metals, the electrode pattern 140 may be formed of metal silver formed by exposing/developing a silver salt emulsion layer, indium tin oxide (ITO), PEDOT/PSS, carbon nanotube (CNT), graphene, zinc oxide (ZnO), Al-doped zinc oxide (AZO), and the like.

The adhesive layer 150 serves to bond one surface of the window 110 to the transparent substrate 130. Here, the adhesive layer 150 may be an optical clear adhesive (OCA), but all kinds of adhesives known to those skilled in the art may be used. Meanwhile, as described above, the printing part 120 is buried in one surface of the window 110 and therefore, a step does not occur on one surface of the window 110. Therefore, when the one surface of the window 110 and the transparent substrate 130 are bonded, it is possible to minimize the occurrence of bubbles on the adhesive layer 150. As such, it is possible to minimize the occurrence of bubbles on the adhesive layer 150 so as to remove the bubbles without forcibly increasing the pressure within the autoclave. Further, the printing part 120 is buried in the one surface of the window 110 to remove a step due to the thickness of the printing part 120, such that the adhesive layer 150 having a minimum thickness may be used without using the adhesive layer 150 more than necessary for absorbing the step.

Meanwhile, an edge of the electrode pattern 140 is provided with the electrode wiring 160 that receives an electrical signal from the electrode pattern 140. Here, the electrode wiring 160 may be formed in an area corresponding to the printing part 120 so as not to be recognized by a user. Further, the electrode wiring 160 may be formed of copper (Cu), aluminum (Al), gold (Au), silver (Ag), titanium (Ti), palladium (Pd), and chromium (Cr) all of which have excellent electric conductivity, or a combination thereof; but the preferred embodiment of the present invention is not limited thereto. Therefore, the electrode wiring 160 may also be formed of indium tin oxide (ITO), PEDOT/PSS, carbon nanotube (CNT), grapheme, zinc oxide (ZnO), Al-doped zinc oxide (AZO), and the like. Meanwhile, the electrode wirings 160 may be integrally formed with the electrode patterns 140, if necessary. As such, it is possible to previously prevent a bonding defect between the electrode wirings 160 and the electrode patterns 140 by integrally forming the electrode wirings 160 and the electrode patterns 140, simplify a manufacturing process, and shorten lead time.

In addition, a flexible printed circuit board 170 connecting the electrode wiring 160 with an integrated circuit 180 may additionally be provided. In detail, one end of the flexible printed circuit board 170 may be connected with the electrode wiring 160 by a conductive adhesive material 175 such as an anisotropic conductive film (ACF), an anisotropic conductive adhesive, and the like. Further, the other end of the flexible printed circuit board 170 may be mounted with the integrated circuit 180.

Meanwhile, a bottom surface of the transparent substrate 130 may be provided with an anti-reflection film (AR film) 190 bonded by the optical clear adhesive 195. Here, the AR film 190 serves to suppress reflection to prevent glaring or cut off noise occurring from the image display device.

The touch panel 100 according to the preferred embodiment of the present invention may be formed so that the electrode pattern 140 has a double layer structure (see FIG. 1) or a single layer structure (see FIG. 1 or 2). Therefore, the touch panel 100 according to the preferred embodiment of the present invention may be used as a self capacitive type touch panel, a mutual capacitive type touch panel, and the like.

According to the preferred embodiments of the present invention, it is possible to minimize the occurrence of bubbles on the adhesive layer by removing the step occurring due to the thickness of the printing part by burying the printing part in one surface of the window.

Further, according to the preferred embodiments of the present invention, it is possible to minimize the occurrence of bubbles on the adhesive layer so as to remove the bubbles without forcibly increasing the pressure within the autoclave.

In addition, according to the preferred embodiments of the present invention, it is possible to use the adhesive layer having a minimum thickness without using the thick adhesive layer more than necessary for absorbing the step, by removing the step occurring due to the thickness of the printing part by burying the printing part on one surface of the window.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a window;
a printing part buried in a depressed part formed on one surface of the window;
a transparent substrate;
an electrode pattern formed on one surface or both surfaces of the transparent substrate; and
an adhesive layer bonding the transparent substrate to one surface of the window.

2. The touch panel as set forth in claim 1, wherein a thickness of the depressed part and a thickness of the printing part are the same.

3. The touch panel as set forth in claim 1, wherein the printing part is formed by sputter.

4. The touch panel as set forth in claim 1, wherein a color of the printing part is black, white, gold, red, green, yellow, gray, violet, brown, and blue, or a combination thereof.

5. The touch panel as set forth in claim 1, wherein the adhesive layer is an optical clear adhesive (OCA).

6. The touch panel as set forth in claim 1, further comprising:
an electrode wiring connected with the electrode pattern.

7. The touch panel as set forth in claim 6, wherein the electrode wiring is integrally formed with the electrode pattern.

8. The touch panel as set forth in claim 6, further comprising:
a flexible printed circuit board connected with the electrode wiring.

9. The touch panel as set forth in claim 1, wherein the electrode pattern is formed of copper (Cu), aluminum (Al), gold (Au), silver (Ag), titanium (Ti), palladium (Pd), and chromium (Cr), or a combination thereof.

10. The touch panel as set forth in claim 1, wherein the electrode pattern is formed of metal silver formed by exposing/developing a silver salt emulsion layer.
